(19) United States
(12) Patent Application Publication
(10) Pub. No.: US 2026/0099779 A1
(43) Pub. Date: Apr. 9, 2026

(54) TECHNIQUES FOR LAYER FUSION GROUP SELECTION IN DEEP LEARNING COMPILERS

(71) Applicant: MEDIATEK INC., Hsinchu (TW)

(72) Inventors: Nien-En Lee, San Jose, CA (US); Tsung-Han Lin, San Jose, CA (US)

(21) Appl. No.: 18/910,130

(22) Filed: Oct. 9, 2024

(51) Int. Cl. G06Q 10/0631; G06Q 10/0633

(52) U.S. Cl. CPC G06Q 10/0631; G06Q 10/0633

(57) ABSTRACT

In an aspect of the disclosure, a method, a computer-readable medium, and an apparatus are provided. The apparatus may be a compiler. The compiler obtains data size of operations in a model graph corresponding to the workflow. The model graph includes multiple operations and an execution order of the operations. The compiler determines one or more operation fusion groups based on data sizes of adjacent operations and a storage capacity of one or more target memories, the intermediate data generated during processing by each operation fusion group is not transferred outside a corresponding target memory. The compiler updates the model graph based on the determined one or more operation fusion groups.

### BACKGROUND

### Field

The present disclosure relates generally to computing devices, and more particularly, to techniques of optimizing operation fusion in artificial intelligence (AI) model graphs to improve memory utilization and processing efficiency across multiple levels of memory hierarchy.

### Background

The statements in this section merely provide background information related to the present disclosure and may not constitute prior art.

Artificial intelligence (AI) workflow scheduling often relied on simplistic approaches that did not fully consider the impact of data transfer sizes on performance. In one method, the computation graph is flattened into a linear sequence and operations are scheduled one by one. The method checks if each operation could fit entirely within the fastest memory level (e.g., L1 cache). If an operation's data exceeded the capacity of the target memory level, it would be placed in a slower level, such as L2 cache or DRAM. This sequential approach often led to suboptimal performance as it failed to prioritize the placement of operations with large data transfers in faster memory levels. Consequently, significant performance bottlenecks could arise due to the increased time and energy required to access data from slower memory levels, particularly when the data produced by these operations needed to be immediately consumed by subsequent operations.

Moreover, some approaches lacked the ability to effectively utilize multiple levels of the memory hierarchy, such as L1, L2, and DRAM, in a coordinated manner. This limited their ability to optimize performance for AI workflows with varying data sizes and memory requirements.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a compiler. The compiler obtains data size of operations in a model graph corresponding to the workflow. The model graph includes multiple operations and an execution order of the operations. The compiler determines one or more operation fusion groups based on data sizes of adjacent operations and a storage capacity of one or more target memories, the intermediate data generated during processing by each operation fusion group is not transferred outside a corresponding target memory. The compiler updates the model graph based on the determined one or more operation fusion groups.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a model graph and a schedule in tree representation for an AI workflow.

FIG. 2 is a diagram illustrating an example of operation fusion in image processing within a memory hierarchy.

FIG. 3 is a diagram illustrating an example of operation fusion in an AI workflow with multiple levels of fusion groups.

FIG. 4 is a diagram illustrating the determination of fusion groups in a convolutional neural network.

FIG. 5 is a flowchart of a method for determining fusion groups in an AI workflow.

FIG. 6 is a flowchart of a method for scheduling an AI workflow.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

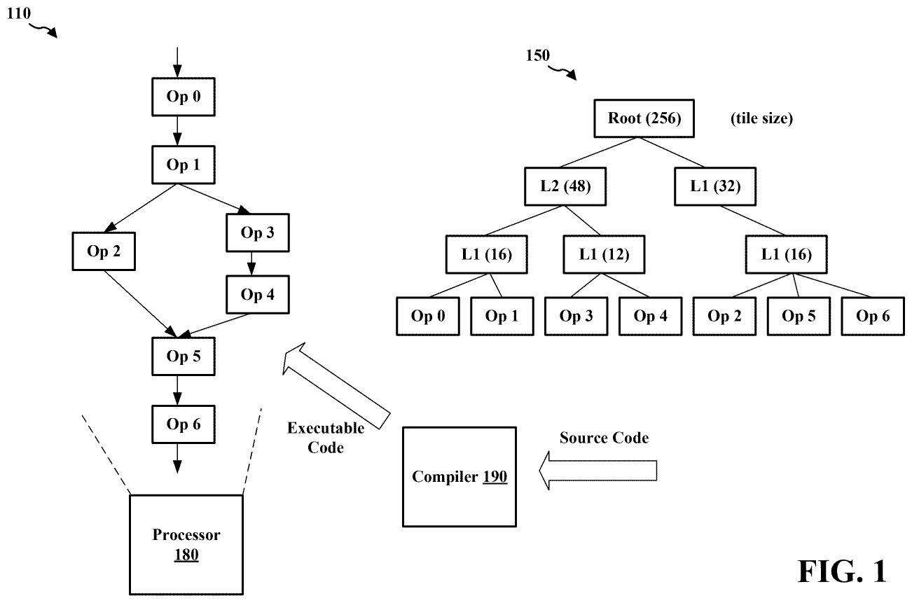

FIG. 1 is a diagram illustrating a model graph 110 and a schedule in tree representation 150. In the model graph 110, each node represents an operation (Op) and each edge represents data flow between the operations. Each operation takes input data, performs a computation, and produces output data, which can then be used as input by a subsequent operation. The operations may be executed on a processor 180. This process creates a chain of operations through which data flows and is processed. For instance, a photo captured by a smartphone can be fed into this workflow as input, where it undergoes various operations (e.g., addition, subtraction) to produce the final output. The schedule in tree representation 150 shows a possible schedule for executing the operations in the model graph 110.

Computer systems use a memory hierarchy, which means that data needs to be transferred between various levels of memory. The memory closer to the CPU or APU typically has smaller capacity but offers faster access speeds. The closest memory to the APU is often referred to as L1 memory, while L2 memory is further away and typically has larger capacity but slower access speed and higher power consumption.

In a first configuration, a significant bottleneck arises from data exchanges across different levels of the memory hierarchy. The computation graph representing the operations is flattened into a linear sequence of operations, and the operations are scheduled one by one. For each operation, the traditional approach checks whether it can be placed entirely within L1 memory. If there is not enough space in L1 memory, the operation is placed in L2 memory or even in DRAM, which is the farthest and slowest memory in the hierarchy. This approach often leads to suboptimal performance because it may place operations that produce large amounts of data in slower memory levels, especially when the data produced by these operations needs to be immediately consumed by the subsequent operations. For example, if several small operations are placed in L1 memory first, it may leave no space for a subsequent operation that produces a large amount of data, forcing it to be placed in slower memory, such as L2 or DRAM. This can result in significant performance degradation due to the increased time and energy required to access data from slower memory levels.

In a second configuration, a compiler 190 takes as input the source code representing the AI workflow, along with information about the target hardware architecture, including the memory hierarchy (L1, L2, DRAM, etc.) and their respective capacities. The AI workflow is typically represented as a model graph, such as the model graph 110 shown in FIG. 1, where nodes represent operations (e.g., convolutional layers in a neural network) and edges represent data flow between operations.

More specifically, the compiler 190 schedules workflows by considering the size of the data being transferred between operations. The compiler 190 prioritizes fusing operations that involve the largest data transfers. The goal is to minimize the movement of large data chunks between slower memory levels, such as L2 or DRAM, and instead keep them within faster memory levels such as L1.

Referring to FIG. 1, the model graph 110 shows the dependencies between different operations (Ops). The edges between the operations represent the data that is transferred between them. The scheduling in the second configuration starts by identifying the edge in the model graph 110 that represents the largest data transfer. For instance, if the edge between Op 0 and Op 1 represents the largest data transfer, this method first attempts to fuse these two operations. Fusing operations means that the output of the first operation (Op 0) is directly fed as input to the second operation (Op 1) without being written back to slower memory levels like DRAM. This is possible if the combined memory requirements of both operations, including their input and output data, can fit within the faster memory level, such as L1.

After fusing Op 0 and Op 1, the compiler 190 proceeds to finding the next largest data transfer edge and attempts to fuse the operations connected by that edge, repeating the process until all edges have been considered. By prioritizing the fusion of operations with large data transfers, this approach aims to keep the most data-intensive operations within the faster memory levels, reducing the frequency and size of data transfers to and from slower memory levels. This can lead to significant improvements in the overall performance and energy efficiency of the AI workflow. The schedule in tree representation 150 in FIG. 1 illustrates a possible outcome of scheduling in the second configuration. The tree structure represents the hierarchical organization of fusion groups. Each node in the tree represents a fusion group, and the leaf nodes represent the individual operations. The size of the fusion group (e.g., 256 tiles for the root node) indicates the maximum memory capacity required to execute all the operations within that group. The fusion groups are organized based on the memory level they are assigned to. For example, the fusion groups at the lowest level of the tree (e.g., L1 (16 tiles)) are assigned to L1 memory, while the higher-level fusion groups (e.g., L2 (48 tiles)) are assigned to L2 memory. The execution order of the operations within a fusion group is determined by the dependencies between the operations, as shown in the model graph 110.

The scheduling techniques in the second configuration can be extended to handle multiple levels of memory hierarchy. For instance, if the AI workflow involves both L1 and L2 memory, the method can first attempt to fuse operations within L1, and then consider fusing operations that cannot fit within L1 into L2 fusion groups. This approach enables efficient utilization of all available memory levels, maximizing the performance of the AI workflow.

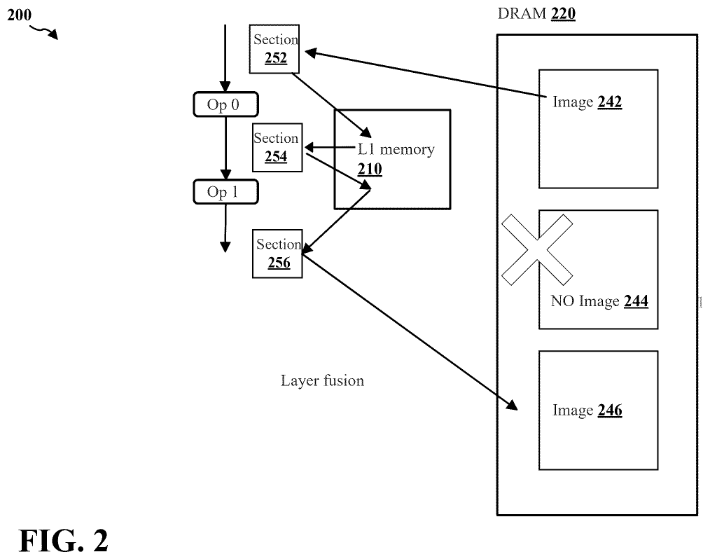

FIG. 2 is a diagram 200 illustrating an example of operation fusion in image processing within a memory hierarchy. This example shows the interaction between DRAM 220, L1 memory 210, and a sequence of operations (Op 0, Op 1) applied to sections of an image.

The diagram showcases two scenarios: one without operation fusion and one with operation fusion. In the scenario without operation fusion, an image 242 stored in DRAM 220 is processed in sections. A section 252 of the image 242 is loaded into L1 memory 210 and processed by Op 0. The output of Op 0, which is a processed section 254, is then stored back into DRAM 220. This process is repeated for subsequent sections of the image 242 until the entire image is processed by Op 0. The result of processing the entire image 242 by Op 0, denoted as image 244, is stored in DRAM 220. Subsequently, image 244 is loaded into L1 memory 210 in sections to be processed by Op 1.

In contrast, in the scenario with operation fusion, the section 252 of the image 242 is loaded into L1 memory 210 and processed by Op 0, resulting in the processed section 254. Instead of storing section 254 back into DRAM 220, the processed section 254 is directly passed as input to Op 1 within L1 memory 210. This eliminates the need to write the intermediate result back to DRAM 220 and then read it again for the next operation. The output of Op 1, which is the final processed section 256, is then stored back into DRAM 220.

This fusion of Op 0 and Op I reduces the number of data transfers between L1 memory 210 and DRAM 220, thereby improving the overall processing speed and efficiency. The intermediate storage step in DRAM 220 is eliminated (i.e., the image 244 are not formed in the DRAM 220) when operations are fused. The example in FIG. 2 focuses on the fusion of operations within L1 memory 210. However, the same principles can be extended to other levels of the memory hierarchy, such as L2 memory.

The proposed AI workflow scheduling method aims to optimize the placement of operations across different memory levels, prioritizing the fusion of operations with large data transfers to keep them within faster memory levels. This approach addresses the problem of data exchange bottlenecks in the first configuration.

The proposed AI workflow scheduling method aims to improve upon approaches in the first configuration for fusing operations in AI workflows. In the first configuration, operations may be fused in sequential order based on the execution flow of the model graph. For example, referring to the model graph 110 in FIG. 1, a traditional approach would first attempt to fuse Op 0 and Op 1, then try to fuse Op 0, Op 1, and Op 3, and so on, following the sequential order of operations.

However, this sequential fusion approach can lead to suboptimal results, particularly when there are large data transfers between non-adjacent operations. For instance, consider a scenario where the data sizes between operations are as follows: 10 units before Op 0, 10 units between Op 0 and Op 1, 10 units between Op 1 and Op 2, 10 units between Op 1 and Op 3, and 100 units between Op 2 and Op 5. The approach in the first configuration may fuse Op 0, Op 1, Op 2, and Op 3 into a single fusion group, but then be unable to include Op 5 due to memory constraints. This would result in the large 100-unit data transfer between Op 2 and Op 5 occurring through slower DRAM, creating a performance bottleneck.

The AI workflow scheduling method in the second configuration prioritizes the fusion of operations with the largest data transfers between them. Instead of following the sequential order of the model graph, this approach first identifies the edges with the largest data transfers and attempts to fuse the operations connected by these edges. In the example above, the method would prioritize fusing Op 2 and Op 5 to keep the 100-unit data transfer within faster memory, even if this means not fusing some of the earlier operations with smaller data transfers.

This AI workflow scheduling method can be implemented using the compiler 190. The compiler 190 first analyzes the model graph to determine the data sizes associated with each edge. It then sorts these edges in descending order based on their data sizes. Starting with the edge representing the largest data transfer, the compiler 190 attempts to fuse the operations connected by this edge, checking if the combined memory requirements of the operations can fit within the target memory level (e.g., L1 memory 210).

If the fusion is possible, the compiler 190 creates a fusion group containing these operations. It then moves on to the next largest data transfer and repeats the process. If a fusion is not possible due to memory constraints, the compiler 190 moves on to the next edge in the sorted list. This process continues until all edges have been considered.

The resulting fusion groups are in the tree representation 150 shown in FIG. 1. Each node in this tree represents a fusion group, with the leaf nodes corresponding to individual operations. The size values associated with each node (e.g., 256 tiles for the root memory, 48 tiles for the L2 memory) indicate the memory requirements for that fusion group.

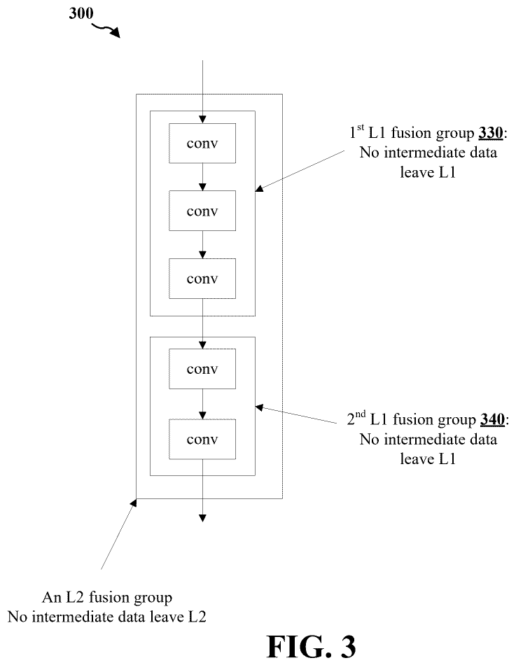

FIG. 3 illustrates an example of operation fusion in an AI workflow with multiple levels of fusion groups. This figure shows a sequence of five convolutional operations (conv) organized into one 1^{st} L1 fusion group 330 and one 2^{nd} L1 fusion group 340. This organization demonstrates how the AI workflow scheduling method in the second configuration can be extended to handle multiple levels of memory hierarchy.

The 1^{st} L1 fusion group 330 contains the first three convolutional operations, The 2^{nd} L1 fusion group 340 encompasses the remaining two convolutional operations. Typically, After the 1^{st} L1 fusion group 330 is done, the data in L1 memory for the 1^{st} L1 fusion group 330 is no longer needed, and can therefore be cleared and leave for the next L1 fusion group (e.g., the 2^{nd} L1 fusion group 340).

This 1^{st} L1 fusion group's 330 grouping indicates that the data produced and consumed by these three operations can all be kept within L1 memory, and 2^{nd} L1 fusion group's 340 grouping indicates that the data produced and consumed by these two operations can all be kept within L1 memory, which is the fastest and closest to the processor. By keeping these operations within L1 memory, the method minimizes data transfers to slower memory levels, thereby improving processing speed and efficiency.

In this example, the total data size between the 1^{st} L1 fusion group 330 and the 2^{nd} L1 fusion group 340 exceeds the L1 memory capacity but is less than L2 memory capacity, therefore, the 1^{st} L1 fusion group 330 and the 2^{nd} L1 fusion group 340 can be executed within L2 memory. L2 memory is typically larger but slower than L1 memory. By creating an L2 fusion group, the method allows for efficient execution of operations that are too large for L1 memory without resorting to the much slower DRAM.

This method can be extended to any number of memory levels in the hierarchy, including potential L3 or even deeper levels. This method fuses operations at the highest (fastest) possible memory level while respecting the memory constraints at each level.

The method starts by identifying the edge (representing data transfer between operations) with the largest data size. It then attempts to fuse the operations connected by this edge into the highest possible memory level (e.g., L1). If the fusion is not possible at L1 due to memory constraints, the method tries to fuse the operations at the next memory level (e.g., L2).

This process continues iteratively, considering edges in descending order of data size and attempting to fuse operations at the highest possible memory level. The result is a hierarchical structure of fusion groups, as seen in FIG. 3, where operations are grouped to minimize data movement between memory levels.

For example, in FIG. 3, the first three conv operations form an L1 fusion group 330 because their combined memory requirements fit within L1 memory. The next two conv operations, which might be too large to fit in L1 when combined with the first three, form a separate L2 fusion group 340. This arrangement allows for efficient execution of all five operations while minimizing data transfers to DRAM.

This approach in the second configuration improves upon the first configuration, which simply places operations sequentially into memory levels until each level was full. By considering data sizes and prioritizing the fusion of operations with large data transfers, the method in the second configuration can potentially achieve much better performance by keeping more data in faster memory levels and reducing costly data transfers to and from DRAM.

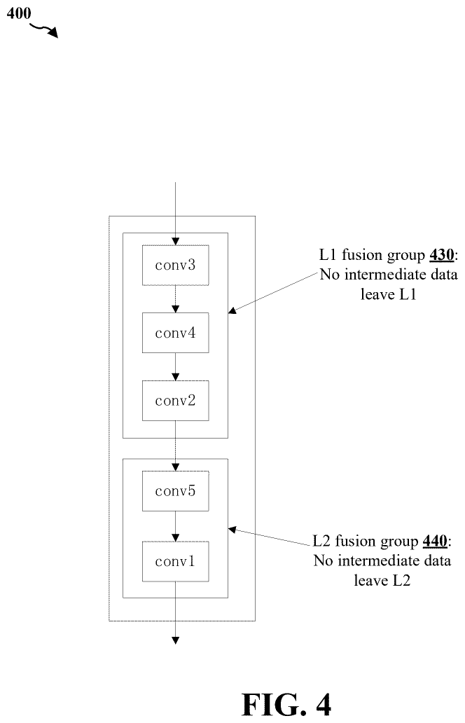

FIG. 4 is a diagram 400 illustrating the determination of fusion groups in a convolutional neural network. The diagram shows a sequence of five convolutional layers: conv1, conv2, conv3, conv4, and conv5. These layers are organized into fusion groups based on their data sizes and the available memory capacity at different levels of the memory hierarchy.

The method for determining fusion groups begins by identifying the edge with the largest data transfer. In this example, the edge between conv5 and conv1 represents the largest data transfer. The compiler 190 first attempts to fuse these operations into an L1 fusion group. However, the total data size between conv5 and conv1 exceeds the available L1 memory capacity. As a result, the compiler 190 then attempts to fuse these operations into an L2 fusion group.

In this example, the total data size between conv5 and conv1 is less than the L2 memory capacity, these two operations are designated as an L2 fusion group 440. All intermediate data generated during the execution of conv5 and conv1 will remain within L2 memory, avoiding costly data transfers to and from DRAM 220.

Next, the compiler 190 considers the edge with the next largest data transfer, which is between conv3 and conv4. The total data size between these operations is evaluated against the available L1 memory capacity. In this example, this data size is less than the L1 memory capacity, conv3 and conv4 are designated as an L1 fusion group 430. All intermediate data generated during the execution of conv3 and conv4 will remain within L1 memory 210.

Finally, the compiler 190 evaluates conv2. It first checks if the data size of conv2 is less than the remaining L1 memory capacity after accounting for the L1 fusion group 430. In this case, as shown in FIG. 4, conv2 can be included in the L1 fusion group 430. Therefore, the final L1 fusion group 430 includes conv3, conv4, and conv2.

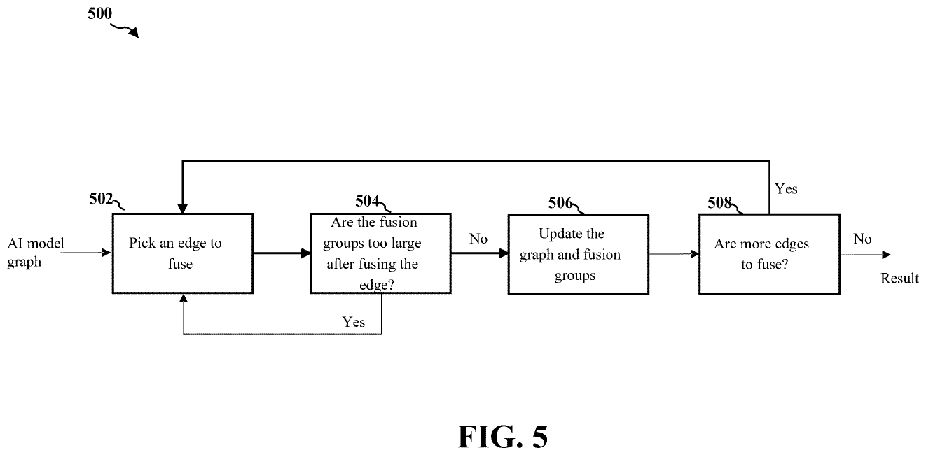

FIG. 5 is a flowchart 500 of a method for determining fusion groups in an AI workflow, particularly focusing on the fusion of operations based on data transfer sizes to optimize memory utilization and processing efficiency. This method can be implemented by the compiler 190 to schedule the execution of AI workflows represented by a model graph, such as the model graph 110 shown in FIG. 1.

At block 502, the compiler 190 picks an edge in the model graph to evaluate for potential fusion. The edges in the model graph represent data transfers between operations. The selection of the edge can be based on various criteria, such as the size of the data transfer represented by the edge. As discussed in the AI workflow scheduling method, the compiler 190 may prioritize edges with larger data transfers to maximize the benefits of fusion in terms of reducing data movement between slower memory levels. Initially, the compiler 190 may select the edge representing the largest data transfer in the model graph.

At block 504, the compiler 190 determines whether fusing the operations connected by the selected edge would result in fusion groups that are too large to fit within the target memory level. For example, if the compiler 190 is attempting to fuse operations into an L1 fusion group, it checks if the combined memory requirements of the operations, including their input and output data, exceed the capacity of L1 memory 210. If the fusion groups are determined to be too large, the compiler 190 returns to block 502 to pick a different edge for evaluation. As such, the fusion groups created do not violate the memory constraints of the target memory level. If the fusion groups are not too large, the compiler 190 proceeds to block 506.

At block 506, the compiler 190 updates the model graph and the fusion groups based on the determined fusion. This update involves merging the operations connected by the selected edge into a single fusion group. The model graph is modified to reflect this fusion, and the fusion group information is updated accordingly. For instance, if the compiler 190 fuses Op 0 and Op 1 in FIG. 1, the model graph 110 would be updated to represent these two operations as a single entity within a fusion group, and the corresponding fusion group information would be updated to include both Op 0 and Op 1.

At block 508, the compiler 190 checks if there are more edges in the model graph to consider for fusion. If there are more edges, the compiler 190 returns to block 502 to continue the process of selecting edges and evaluating fusion possibilities. This iterative process allows the compiler 190 to explore different fusion combinations and potentially find an optimal or near-optimal fusion configuration that minimizes data movement between memory levels. If there are no more edges to consider, the compiler 190 proceeds to block 510.

At block 510, the compiler 190 determines that the fusion process is complete, and the resulting fusion groups represent a schedule for executing the AI workflow. This schedule indicates which operations are fused together and the memory level assigned to each fusion group. The schedule can be represented in a tree structure, such as the schedule in tree representation 150 shown in FIG. 1.

The compiler 190 takes as input the source code representing the AI workflow, along with information about the target hardware architecture, including the memory hierarchy (L1, L2, DRAM, etc.) and their respective capacities. The AI workflow is typically represented as a model graph, such as the model graph 110 shown in FIG. 1, where nodes represent operations (e.g., convolutional layers in a neural network) and edges represent data flow between operations.

The compiler 190 performs the following steps described supra referring to the flowchart 500 to compile the source code. For each fusion group, the compiler generates code that keeps all intermediate data within the designated memory level. It eliminates unnecessary data transfers to and from DRAM for operations within the same fusion group. The compiler may use specific instructions or intrinsics to ensure data remains in the target memory level. The output of the compiler 190 is optimized executable code that implements the AI workflow with the determined fusion groups. This code is designed to minimize data movement between slower memory levels (e.g., DRAM) and maximize data reuse within faster memory levels (e.g., L1, L2), as described supra. The compiler 190 can run on various computing devices that each may have a central processing unit (CPU), a memory (RAM), a storage (hard drive or solid-state drive), and various peripherals. The compiler 190 can be executed on the CPU.

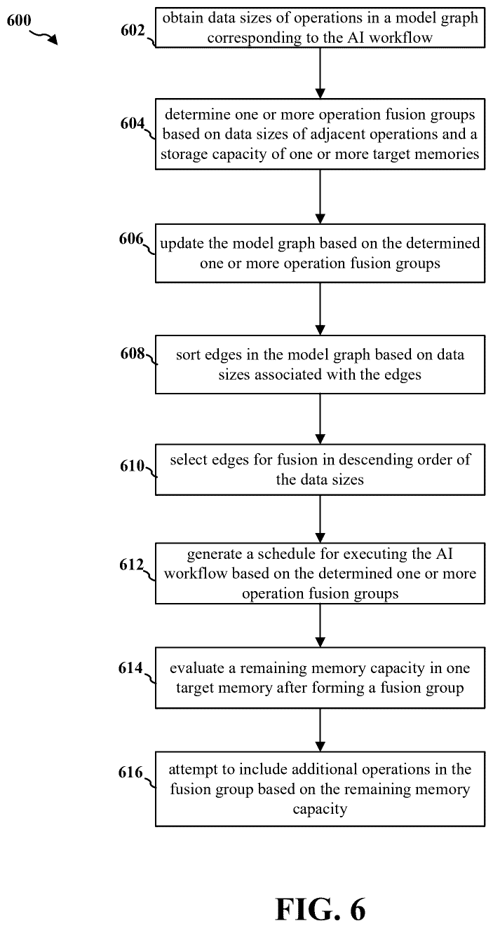

FIG. 6 is a flowchart 600 of a method for scheduling a workflow. The method may be performed by a compiler (e.g. the compiler 190). In operation 602, the compiler obtains data sizes of operations in a model graph corresponding to the workflow, wherein the model graph includes multiple operations and an execution order of the operations.

In operation 604, the compiler determines one or more operation fusion groups based on data sizes of adjacent operations and a storage capacity of one or more target memories, wherein intermediate data generated during processing by each operation fusion group is not transferred outside a corresponding target memory. In operation 606, the compiler updates the model graph based on the determined one or more operation fusion groups.

In operation 608, the compiler sorts edges in the model graph based on data sizes associated with the edges. In operation 610, the compiler selects edges for fusion in descending order of the data sizes.

In certain configurations, the compiler identifies an edge in the model graph representing a largest data transfer among edges that are not in a fusion group. The compiler attempts to fuse operations connected by the identified edge into a fusion group for a first target memory; and, if fusion is not possible for the first target memory, the compiler attempts to fuse the operations into a fusion group for a lower level memory.

In certain configurations, one or more target memories comprises at least one of an L1 memory and an L2 memory in a memory hierarchy. In certain configurations, the compiler merges operations in each fusion group into a single entity within the model graph. In certain configurations, the workflow comprises a convolutional neural network.

In certain configurations, determining the one or more operation fusion groups comprises iteratively selecting edges and attempting to fuse operations connected by the selected edges until all edges have been considered.

In operation 612, the compiler generates a schedule for executing the workflow based on the determined one or more operation fusion groups, wherein the schedule specifies an execution order for the operations within each fusion group and a memory level assigned to each fusion group.

In operation 614, the compiler evaluates a remaining memory capacity in one target memory after forming a fusion group. In operation 616, the compiler attempts to include additional operations in the fusion group based on the remaining memory capacity.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of scheduling a workflow, comprising:
obtaining data sizes of operations in a model graph corresponding to the workflow, wherein the model graph includes multiple operations and an execution order of the operations;
determining one or more operation fusion groups based on data sizes of adjacent operations and a storage capacity of one or more target memories, wherein intermediate data generated during processing by each operation fusion group is not transferred outside a corresponding target memory; and
updating the model graph based on the determined one or more operation fusion groups.

2. The method of claim 1, further comprising:
sorting edges in the model graph based on data sizes associated with the edges; and
selecting edges for fusion in descending order of the data sizes.

3. The method of claim 1, wherein determining the one or more operation fusion groups comprises:
identifying an edge in the model graph representing a largest data transfer among edges that are not in a fusion group;
attempting to fuse operations connected by the identified edge into a fusion group for a first target memory; and
if fusion is not possible for the first target memory, attempting to fuse the operations into a fusion group for a lower level memory.

4. The method of claim 1, wherein the one or more target memories comprises at least one of an L1 memory and an L2 memory in a memory hierarchy.

5. The method of claim 1, wherein updating the model graph comprises:
merging operations in each fusion group into a single entity within the model graph.

6. The method of claim 1, wherein the workflow comprises a convolutional neural network.

7. The method of claim 1, wherein determining the one or more operation fusion groups comprises iteratively selecting edges and attempting to fuse operations connected by the selected edges until all edges have been considered.

8. The method of claim 1, further comprising:
generating a schedule for executing the workflow based on the determined one or more operation fusion groups, wherein the schedule specifies an execution order for the operations within each fusion group and a memory level assigned to each fusion group.

9. The method of claim 1, further comprising:
evaluating a remaining memory capacity in one target memory after forming a fusion group; and
attempting to include additional operations in the fusion group based on the remaining memory capacity.

10. An apparatus for scheduling a workflow, comprising:
a memory; and
at least one processor coupled to the memory and configured to:
obtain, data sizes of operations in a model graph corresponding to the workflow, wherein the model graph includes multiple operations and an execution order of the operations;
determine, one or more operation fusion groups based on data sizes of adjacent operations and a storage capacity of one or more target memories, wherein intermediate data generated during processing by each operation fusion group is not transferred outside a corresponding target memory; and
update, the model graph based on the determined one or more operation fusion groups.

11. The apparatus of claim 10, wherein the processor further configured to:
sort edges in the model graph based on data sizes associated with the edges; and
select edges for fusion in descending order of the data sizes.

12. The apparatus of claim 10, wherein to determine the one or more operation fusion groups, the at least one processor is further configured to:
identify an edge in the model graph representing a largest data transfer among edges that are not in a fusion group;
attempt to fuse operations connected by the identified edge into a fusion group for a first target memory; and
if fusion is not possible for the first target memory, attempt to fuse the operations into a fusion group for a lower level memory.

13. The apparatus of claim 10, wherein the one or more target memories comprises at least one of an L1 memory and an L2 memory in a memory hierarchy.

14. The apparatus of claim 10, wherein to update the model graph, the at least one processor is further configured to:
merging operations in each fusion group into a single entity within the model graph.

15. The apparatus of claim 10, wherein the workflow comprises a convolutional neural network.

16. The apparatus of claim 10, wherein to determine the one or more operation fusion groups, the at least one processor is further configured to iteratively select edges and attempt to fuse operations connected by the selected edges until all edges have been considered.

17. The apparatus of claim 10, wherein the processor is further configured to:
generate a schedule for executing the workflow based on the determined one or more operation fusion groups, wherein the schedule specifies an execution order for the operations within each fusion group and a memory level assigned to each fusion group.

18. The apparatus of claim 10, wherein the processor is further configured to:
evaluate a remaining memory capacity in one target memory after forming a fusion group; and
attempt to include additional operations in the fusion group based on the remaining memory capacity.

19. A computer-readable medium storing computer executable code for scheduling a workflow, comprising code to:
obtain, data sizes of operations in a model graph corresponding to the workflow, wherein the model graph includes multiple operations and an execution order of the operations;
determine, one or more operation fusion groups based on data sizes of adjacent operations and a storage capacity of one or more target memories, wherein intermediate data generated during processing by each operation fusion group is not transferred outside a corresponding target memory; and
update, the model graph based on the determined one or more operation fusion groups.

20. The computer-readable medium of claim 19, further comprising code to:
sort edges in the model graph based on data sizes associated with the edges; and
select edges for fusion in descending order of the data sizes.
